(19) United States
(12) Patent Application Publication
(10) Pub. No.: US 2023/0339297 A1
(43) Pub. Date: Oct. 26, 2023

(54) TRANSPARENT SUN VISOR FOR VEHICLES

(71) Applicant: Oviation B.V., Heerlen (NL)

(72) Inventor: Hamid-Reza NAJAF POUR AGHCHESHMEH, Heerlen (NL)

(21) Appl. No.: 17/787,446

(22) PCT Filed: Dec. 22, 2020
(86) PCT No.: PCT/EP2020/087667

§ 371 Date: Jun. 20, 2022

(30) Foreign Application Priority Data
Dec. 23, 2019 (DE) 10 2019 135 757.8

(51) Int. Cl. G02F 1/1347; B60J 3/04; G02F 1/1334

(52) U.S. Cl. CPC B60J 3/04; G02F 1/13347; G02F 1/13471; G02F 2202/28; G02F 2203/66

(57) ABSTRACT

The invention relates to a sun visor for a vehicle with electrically switchable optical characteristics.

### CROSS-REFERENCE TO RELATED APPLICATION(S)

This application is a U.S. National Stage Entry Under 35 U.S.C. 371 of International Application No. PCT/EP2020/087667 filed on Dec. 22, 2020, which claims priority to German Patent Application No. 10 2019 135 757.8 filed on Dec. 23, 2019, the contents of which are incorporated herein by reference in their entirety.

### FIELD OF THE INVENTION

The invention relates to a transparent sun visor for vehicles having electrically switchable optical properties.

### BACKGROUND OF THE INVENTION

According to WIKIPEDIA (keyword Smart Glass, inquiry of Jun. 28, 2019), the term Smart Glass defines tintable glazing whose transparency can be changed by applying a voltage (electrochromism), altered light situations (photochromism), or heating (thermochromism). Different techniques and fields of application are summarized under the generic term of “smart glass”. Depending on the design, such glasses may serve, for example, as sun protectors (the glass remains transparent), or adopt the function of a sight protector (the glass becomes opaque).

DE 38 23780 A relates to a sun protector, especially for reducing the light incidence into the interior of vehicles while maintaining the ability to look outside, designed as a flexible multilayer plastic sheet having a transparent base layer and a transparent outer layer at least one one side thereof. In order to reduce transparency without perforating an opaque sheet, it is proposed to provide a thin layer of a substantially opaque material that is interrupted in the shape of a fine pattern between a base layer and an outer layer.

WO 2014/086555A1 relates to a glazing having electrically switchable optical properties, at least comprising: an outer pane and a switchable functional element which is connected to the outer pane through at least one surface via at least one thermoplastic film, wherein the thermoplastic film contains at least one luminescent material.

WO 2014/072138A1 relates to glazing having switchable optical properties, at least comprising: a transparent substrate having an outer surface and an inner surface, a reflection layer on the outer surface and/or on the inner surface and a switchable functional element arranged on the interior side with respect to the reflection layer, wherein the reflection layer contains a material having a refractive index n_{R} of 1.6 to 2.5, and wherein the product of the refractive index n_{R} and the thickness d of the reflection layer is from 250 nm to 960 nm.

US 2014/0268289 A1 describes an electrochromic variable transmission window comprising: first and second substantially transparent substrates having associated therewith electrically conductive materials; an electrochromic medium contained in a chamber disposed between the first and second substrates and containing at least one solvent, at least one anodic electroactive material, at least one cathodic electroactive material, and at least one of the anodic and cathodic electroactive materials; and wherein the electrochromic window has an E_{y} of less than about 20, and more preferably less than about 5, while in a low transmittance state under normal daylight conditions.

US 2015/103280 A describes an intelligent electronic sun protection with an integrated glass plate and a liquid crystal film attached to the glass plate. The liquid crystal film is formed with a plurality of display areas, and the liquid crystal film of the display area is cut into stripes or is mainly formed in a stripe shape with the display areas abutting each other. A controller is installed between the display areas and a power source and connected to an input unit which is used to transmit signals and generate power control to the controller. The controller controls the liquid crystal film of the display areas to be electrically connected or electrically disconnected to make the liquid crystal film transparent or opaque, respectively, to achieve an effect of simulating various states of partially shading light of a conventional window curtain.

DE 10 226406 A describes an information display device with a display unit that can be pulled down from the inside of the car roof and with a display surface lying parallel to the roof in its horizontal stowage position and hanging vertically therefrom. It is in its working position at the back of the passenger seat. The display area acts as sun protection for a transparent roof section or a transparent sliding roof section in a horizontal stowage position.

DE 10 2012 006 231 A1 relates to a layer arrangement which changes the transmission of light as a function of its temperature, the layer arrangement having a first polarization layer, a switching layer influencing the polarization properties of light as a function of temperature, and a second polarization layer, and an additional NIR transmission-preventing layer.

US 2017/0235030 A1 describes a light-reflecting film that can effectively improve the reflectance for only one particular polarized light while maintaining a high transparency for visible light, and a film for controlling the light, an optical film, a functional glass, and a head-up display. A light reflecting film includes at least two light-reflecting layers, wherein at least two light-reflecting layers include at least one from among the following: a light reflecting layer PRL-1, a light reflecting layer PRL-2, and a light reflecting layer PRL-3, wherein said light reflecting layer PRL-1 has a central reflection wavelength of at least 400 nm, but less than 500 nm, and a reflectivity of ordinary light in the central reflection wavelength of more than or equal to 5%, but less than or equal to 25%, wherein said light reflecting layer PRL-2 has a central reflection wavelength of at least 500 nm, but less than 600 nm, and a reflectivity of ordinary light in the central reflection wavelength of more than or equal to 5%, but less than or equal to 25%, wherein said light reflecting layer PRL-3 has a central reflection wavelength of at least 600 nm, but less than 700 nm, and a reflectivity of ordinary light in the central reflection wavelength of more than or equal to 5%, but less than or equal to 25%, wherein said at least two light reflecting layers have mutually different central reflection wavelengths.

US 2019/0331947 A1 provides a laminate that can not only control the amount of transmitted external light, but can also be used as a mirror. A first laminate includes: a first liquid crystal element; a reflection polarization element, and a second liquid crystal element. The first liquid crystal element has first liquid crystal cells with changing orientation states, and a first polarization element of the absorption type. The first liquid crystal cells can be switched: between a mode in which one kind of polarized light of the incident light is blocked, and the other kind of polarized light, and a mode in which one kind of polarized light of the incident light is blocked, and the other kind of polarized light is shifted and then transmitted; between a mode in which the incident light is transmitted unchanged, and a mode in which one type of the polarized light is blocked, and the other type of the polarized light is transmitted; and between a mode in which one kind of polarized light of the incident light is blocked, and the other kind of polarized light is transmitted, and a mode in which one kind of polarized light of the incident light is transmitted, and the other kind of polarized light is blocked.

The polarization element of the reflection type receives the light transmitted by the first liquid crystal element, transmits one kind of polarized light of the incident light, and reflects the other kind of polarized light. The second liquid crystal element has second liquid crystal cells with changing orientation states, and a second polarization element of the absorption type. When the polarization element of the reflection type has transmitted polarized light, the second liquid crystal cells can be switched between a mode in which the polarized light is blocked, and a mode in which the polarized light is transmitted.

DE 203 13 276 U1 describes the active tinting of windshields only when needed, i.e., in the case of being blinded by oncoming or stationary light sources. The reduction of transparency (translucency) of the windshield is achieved in the fastest possible way by using a transparent liquid crystal pane (liquid crystal sheet), or by some technology with a similar effect.

### BRIEF SUMMARY OF THE INVENTION

In contrast, the object of the present invention is to provide a transparent sun visor that has an electrically switchable, i.e., dimmable, sun and thus blinding protection.

According to an embodiment, disclosed is sun visor for a vehicle having electrically switchable optical properties, wherein the sun visor has maximum translucency and a minimum opacity for light in the visible range in a voltage-free state, and a lower translucency and/or higher opacity for light in the visible range in a state of applied voltage as compared to a voltage-free state. The sun visor comprises:
(a) a first plastic substrate,
(b) a first TN VA liquid crystal cell,
(c) a first intermediate layer, which especially includes an adhesive layer,
(d) optionally a second liquid crystal cell with a PN liquid crystal element TN or VA, especially VA with PN between two transparent electrodes,
(e) a second intermediate layer analogous to the first intermediate layer (c),
(f) a second liquid crystal cell analogous to the first liquid crystal cell, and
(g) a second substrate analogous to the first substrate.

Further essential features of the sun visor are supposed to be the following:
1. Preferably failsafe (“normally white mode, i.e., transparent in the powerless state)
2. homogeneous and color-neutral
3. flexibility of arrangement, e.g., patterns and design, cellular divisions, such as defined locally limited liquid crystal displays, for example, blinds or segments and/or writings
4. power supply preferably in the low voltage range
5. combined blinding and sun protection functions

According to the invention, the term “sun visor” relates to vehicles, especially aircrafts, for example, cockpits, ships, trains and motor vehicles, especially passenger cars, trucks, mobile homes, and buses.

For example, one problem of the prior art with standard sun visors of motor vehicles consists in the replacement and/or retrofitting of known electrochromic or electrotropic sun visors, for example, when a visor fails or is damaged in a motor vehicle. The known systems of the prior art are time-consuming and expensive. Commercially available sun visors in land and water vehicles are usually intransparent and reduce the optical properties when in use, forming a dead angle in some cases.

Accordingly, the object of the present invention is to provide an “intelligent” sun visor.

### DETAILED DESCRIPTION OF THE INVENTION

In a first embodiment, the above object is achieved by a sun visor for a vehicle having electrically switchable optical properties, characterized in that

said sun visor has maximum translucency (transparency), and a minimum opacity for light in the visible range (380 nm to 780 nm, especially 400 nm to 750 nm) in a voltage-free state, and in contrast, has a lower translucency (transparency) and/or higher opacity in a state of applied voltage: leaving sunglasses and the usual sun visor behind. The sun visor according to the invention combines sun visor and sunglasses in itself, and does not interfere with vision when driving. In contrast to the traditional sun visor, the field of vision is retained. The sun visor according to the invention acts only in the range of disturbing and/or blinding sun irradiation, in order to spare the driver the wearing, putting-on and finding of the sun glasses.

Thus, the essential core of the invention preferably describes a “failsafe smartglass window” (optionally further containing solar cells - battery-operated) and thus a replacement solution over the prior art without changes or maintenance, and the providing of a new functionality. The essential advantages of the invention over the above defined prior art reside in its flexibility:
Color neutrality
Complete retention of the field of vision as compared to conventional sun visor
Homogeneity
Narrow rim, for example, less than 3 mm, optionally virtually rimless
Low weight
Low switching time, for example, < 1 s
Thickness of the material glass/substrate freely selectable, for example, from 3 to 8 mm
No blister formation
Longevity

The sun visor according to the invention can be connected directly to the power supply of the vehicle, or provided with an energy source of its own (for example, solar battery). Cumulatively or alternatively, the sun visor according to the invention may also be equipped with RFID and/or energy harvesting or solar cells for a serial novel development. An independent solar power supply renders the sun visor independent of the power supply of the vehicle and is reasonable, in particular, since the function of the sun visor is not required when the light irradiation is low.

In a first embodiment of the invention, the above object is achieved by a sun visor for a vehicle having electrically switchable optical properties, characterized in that the sun visor has maximum (optimum) translucency and a minimum (optimum) opacity for light in the visible range in a voltage-free state, and a lower translucency and/or higher opacity for light in the visible range in a state of applied voltage as compared to a voltage-free state.

In a preferred embodiment of the invention, the sun visor includes from the outside to the inside in a version 1:
(a) a first substrate,
(b) a first liquid crystal cell,
(c) a first intermediate layer, which especially includes an adhesive layer,
(d) optionally a second liquid crystal cell with a PN and/or PD liquid crystal element TN and/or VA, especially VA with PN or TN with PD, between two transparent electrodes,
(e) a second intermediate layer analogous to the first intermediate layer (c),
(f) optionally a second liquid crystal cell analogous to the first liquid crystal cell, and
(g) a second substrate analogous to the first substrate.

In the case where the first liquid crystal cell comprises a PN-VA liquid crystal element or a PD-TN liquid crystal element (f) is not present, the intermediate layer (e) may optionally be omitted.

The second intermediate layer (e) may also be designed in the form of a substrate; in particular in the case where a PN-VA liquid crystal or PD-TN liquid crystal element (d) is not present.

EXAMPLE 1

(a) substrate, for example, of plastic (especially polycarbonate or PMMA)
(b) LC cell VA or ECB or TN mode, especially made of 2 ITO panes or 2 ITO plastic sheets
(c) adhesive composite, for example, by EVA, PVB or OCA bonding
(d) PN or PD or PSC liquid crystal element (for example, ITO glass or plastic)
(e) adhesive composite as above under (c)
(f) second LC cell as above under (b)
(g) substrate as above under (a)

ECB represents electronically controlled birefringence (ECB) mode.

PN represents “polymer network”, i.e., a liquid crystal element bonded to a polymer network.

PD represents “polymer disperse”, i.e., a polymeric liquid crystal element dispersed in a matrix.

Alternatively to the PDLC liquid crystals, so-called PSCLC liquid crystals, i.e., polymer-stabilized cholesteric liquid crystals, which are obtainable by in situ photopolymerization of reactive liquid crystal molecules in the presence of unreactive liquid crystal molecules in a planar oriented Bragg texture, may also be employed, wherein the UV cross-linking is combined with a thermally induced pitch variation.

TN represents “twisted nematic”, i.e., a nematic twisted cell, in which the interior sides between two, mostly thin, substrates are coated with a transparent electrode layer, for example, an indium tin oxide layer, and a liquid crystal layer with a thickness of a few micrometers is located between. In addition, the two substrates are coated with polarization filters twisted by 90°.

VA represents “vertical alignment”. In VA LCDs, homeotropic liquid crystals, i.e., liquid crystals oriented perpendicular to the substrate surface, are switched parallel to the glass substrate by applying an electric field that is oriented perpendicular to the substrate. Thus, liquid crystal mixtures with a negative dielectric anisotropy, which orient themselves perpendicular to the electric field, are required. This is achieved by incorporating lateral polar side groups into mesogenic molecules.

In a voltage-free state, the homeotropic orientation of the liquid crystals results at first in an almost ideal black state between crossed polarizers. Therefore, VA displays are characterized by excellent contrast values and are usually operated in a “normally black mode”. This means that the screen is tinted in a voltage-free state, for example, in black (dark).

OCA represents “optical clear adhesive”, i.e., an optically invisible adhesive.

In a version 2, layers (d) and (f) are interchanged as compared to version 1, so that a sketcher impression, i.e., a milky white haze, is in the foreground.

EXAMPLE 2

(a) substrate, for example, of plastic (especially polycarbonate or PMMA)
(b) LC cell VA or ECB or TN mode, especially made of 2 ITO panes or 2 ITO plastic sheets
(c) adhesive composite, for example, by EVA, PVB or OCA bonding
(d) second LC cell as above under (b)
(e) adhesive composite as above under (c)
(f) PN liquid crystal or PD or PSC liquid crystal element (ITO glass or plastic)
(g) substrate as above under (a)

The advantages of the present invention reside in the flexibility of light transmission. In addition, the combination of privacy (opaque) and sun protection (dark) is supplemented in one, above all as a failsafe solution. Optical flexibility from a variable multilayer combination is also possible; see, for example, the transition from Example 1 to Example 2, which optionally could also have, for example, a total of 8 layers.

Particularly preferred according to the present invention is a sun visor, characterized in that said first and/or second liquid crystal element comprises a commercially available liquid crystal mixture between two panes (sheets) coated with transparent conductive oxides. Corresponding elements are commercially available, for example, from the Merck company.

A sun visor according to the present invention is particularly preferred if it is characterized in that the VA liquid crystal or TN liquid crystal element, if any, are also colorless and transparent in an unpowered state. The advantage resides in the fail safety. If the power fails, the passengers can still look through (VA and PN).

Particularly preferred according to the present invention is a sun visor as defined above that is characterized in that said first and/or second liquid crystal elements form first and/or second polarization layers, which switch translucency as a function of the voltage applied. Here too, the advantage resides in the fail safety. Otherwise, this would not be an advantage in the presence of PN and VA liquid crystal elements. Preferably, both systems should be failsafe.

Using the present invention, sun visors can be successfully provided that are characterized in that the haze as determined using a hazemeter NDH 2000 with standard illuminant D65 in the range of the visible light is less than 1%, especially less than 0.5%, in a voltage-free state. Thus, the sun visor is virtually clear and transparent in a voltage-free state. In the same voltage state, the transmission can also be measured with a hazemeter NDH 2000 with standard illuminant D65 to be at least 50%, especially at least 60%. Thus, the layer structure according to the invention is virtually invisible with the naked eye under usual conditions. The haze and the transmission are measured as usual in the prior art with the overall sun visor using the standard illuminant D65 (see WIKIPEDIA, keyword “standard illuminant”, date of inquiry Jun. 28, 2019).

According to the invention, when a voltage is applied, a haze of more than 70%, especially more than 80%, can be measured with a hazemeter NDH 2000 with standard illuminant D65, and/or a transmission in a voltage state of up to 20%, especially up to 10%, can be measured with a hazemeter NDH 2000 with standard illuminant D65.

Optionally, the sun visor may comprise segmented switching zones of the cells for a locally limited light-dark and/or transparent-opaque control. The power supply and control of the glazing or of individual cells is effected, in particular, by external connections to the onboard power system. For example, control is effected by a flat flexible control unit (PCB) with the vehicle’s (optionally) BUS system battery, which stores voltage, for example, from solar cells, allowing for the individual (voltage) switching states. Thus, autonomous function and control of the properties of the sun visor and of individual cells are possible.

A sun visor according to the invention may further have a separate or integrated screen/display means, because it is possible according to the invention to control active or passive matrices, with which, for example, the speed, time of day, danger signs, warning signs (belt), etc., can be displayed. In the same way, (small) OLED displays can also be embedded.

In another preferred embodiment of the invention, the sun visor comprises a flexible, optionally embedded, solar-cell operated battery integrated therein, for example, with a touch function in the operating unit. The operation will then be effected by a touch membrane. These touch elements are transformed to function through the PCB (BUS system) or control elements as ON, OFF and switch commands. The user can operate the glazing directly at the sun visor, for example, at the sun visor itself or at a separate operating unit, by touching the optionally masked touch zones.

### Example

Description of state:
Switched off: clear, bright: Failsafe includes a VA (vertical alignment), PNLC polymer network liquid crystal as the first liquid crystal layer
Switched on: hazy, optionally dark, TN (twisted nematic), PDLC polymer dispersed liquid crystal
A: Cross-section structure double cells 1 + 2: only sun protection (only TN with TN, or VA with VA:
B: Cross-section structure double cells A + 3: Sun protection in combination with privacy effect.
   1. Layer 2 × 0.2 mm (substrate: glass or plastic, especially polycarbonate) TN or VA cell (total of 1.1 mm)
   2. Layer 2 × 0.2 mm (substrate: glass or plastic, especially polycarbonate) TN or VA cell (total of 1.1 mm)
   Optionally 0.4 mm PNLC, PN or PDLC, PC or PSC (optionally with privacy effect).Only PNLC and VA can be combined to achieve Fail Safe. Otherwise, PDLC or PSC must be combined with TN.

### Description of Structure

Joining the elements with optically clear adhesive (OCA) or laminating press connecting method.

Laminating: The substrates, cells or sheets were laminated by means of EVA and/or OCA in a composite method.

Example: TN cells can be connected by means of OCA or by laminating by means of EVA.

STRUCTURE: Double cell

(a) protective pane, for example, of plastic (especially polycarbonate or PMMA)
(b) LC cell VA or ECB or TN mode, especially made of 2 ITO panes or 2 ITO plastic sheets
(c) adhesive composite, for example, by EVA, PVB or OCA bonding
(d) second LC cell as above under (b)
(e) adhesive composite as above under (c)
(f) PN liquid crystal and/or PD or PSC liquid crystal element (ITO glass or plastic)
(g) protective pane as above under (a)

### The Advantages

PMMA and PC substrates result in a low weight and a high safety. Registration for road traffic or air traffic is unproblematic.

### Technical Data for Power Supply

If not present, a DC-AC converter may be necessary.

Input voltage: 12-28 V DC-AC converter with 0.04 A - 0.09 A.

A primary voltage of 9-16 V maintains the permanent state.

1. A sun visor for a vehicle having electrically switchable optical properties, wherein the sun visor has maximum translucency and a minimum opacity for light in the visible range in a voltage-free state, and a lower translucency and/or higher opacity for light in the visible range in a state of applied voltage as compared to a voltage-free state, wherein the sun visor comprises:
(a) a first plastic substrate,
(b) a first TN VA liquid crystal cell,
(c) a first intermediate layer, which includes an adhesive layer,
(d) optionally a second liquid crystal cell with a PN liquid crystal element TN or VA, the VA with PN between two transparent electrodes,
(e) a second intermediate layer analogous to the first intermediate layer (c),
(f) a second liquid crystal cell analogous to the first liquid crystal cell, and
(g) a second substrate analogous to the first substrate.

2. The sun visor according to claim 1, wherein the first and/or second substrate and/or the intermediate layer respectively comprise poly(methyl methacrylate) or polycarbonate.

3. The sun visor according to claim 1, wherein the first and/or second liquid crystal element comprises a liquid crystal mixture between two panes or sheets coated with transparent conductive oxides.

4. The sun visor according to claim 1, wherein the first and second liquid crystal elements form first and second polarization layers, which switch translucency as a function of the voltage applied.

5. The sun visor according to claim 1, wherein the PN VA liquid crystal or PD TN liquid crystal element is transparent in a powerless state.

6. The sun visor according to claim 1, wherein the haze as determined using a hazemeter NDH 2000 with standard illuminant D65 in the range of the visible light is less than 1%, in a voltage-free state.

7. The sun visor according to claim 1, wherein transmission in a voltage-free state is measured with a hazemeter NDH 2000 with standard illuminant D65 to be at least 50%.

8. The sun visor according to claim 1, wherein when a voltage is applied, a haze of more than 70% is measured with a hazemeter NDH 2000 with standard illuminant D65, and/or a transmission of up to 20%, is measured with thea hazemeter NDH 2000 with standard illuminant D65.

9. The sun visor according to claim 1 comprising segmented switching zones for light-dark and/or transparent-opaque control.

10. The sun visor according to claim 1, further comprising a screen/display means.

11. The sun visor according to claim 2, wherein the first and/or second liquid crystal element comprises a liquid crystal mixture between two panes or sheets coated with transparent conductive oxides.

12. The sun visor according to claim 2, wherein the first and second liquid crystal elements form first and second polarization layers, which switch translucency as a function of the voltage applied.

13. The sun visor according to claim 3, wherein the first and second liquid crystal elements form first and second polarization layers, which switch translucency as a function of the voltage applied.

14. The sun visor according to claim 2, wherein the PN VA liquid crystal or PD TN liquid crystal element is transparent in a powerless state.

15. The sun visor according to claim 6, wherein the haze is less than 0.5%.

16. The sun visor according to claim 1, wherein transmission in a voltage-free state is measured with a hazemeter NDH 2000 with standard illuminant D65 to be at least 60%.

17. The sun visor according to claim 1, wherein when voltage is applied, a haze of more than 80% is measured with a hazemeter NDH 2000 with standard illuminant D65, and/or a transmission of up to 10%, is measured with the hazemeter NDH 2000 with standard illuminant D65.

18. The sun visor according to claim 2, comprising segmented switching zones for light-dark and/or transparent-opaque control.
